(19) United States
(12) Patent Application Publication
(10) Pub. No.: US 2021/0201274 A1
(43) Pub. Date: Jul. 1, 2021

(54) VEHICLE REPAIR MATERIAL PREDICTION AND VERIFICATION SYSTEM

(71) Applicant: 3M INNOVATIVE PROPERTIES COMPANY, St. Paul, MN (US)

(72) Inventors: Michael E. O'Brien, White Bear Lake, MN (US); Shawn M. Ryan, Stillwater, MN (US); Kristin L Thunhorst, Stillwater, MN (US); Andrew W. Long, Woodbury, MN (US)

(21) Appl. No.: 17/199,077

(22) Filed: Mar. 11, 2021

Related U.S. Application Data
(63) Continuation-in-part of application No. PCT/IB2020/058886, filed on Sep. 23, 2020.
(60) Provisional application No. 62/913,573, filed on Oct. 10, 2019.

(51) Int. Cl. G06Q 10/00; G06N 20/00; G07C 5/08; B60S 5/00

(52) U.S. Cl. CPC G06Q 10/20; B60S 5/00; G07C 5/085; G06N 20/00

(57) ABSTRACT

A method includes determining, based on current repair data and at least one of historical repair data or existing repair specifications, a predicted material to be used during a vehicle repair, the vehicle repair including replacing or repairing a part of a vehicle. The material includes at least one of an adhesive, an abrasive, a tape, a paint, a coating, or a tool. The method also includes outputting data indicating the predicted material in a predicted material repair plan.

### TECHNICAL FIELD

This disclosure relates to vehicle repairs and computing systems used for coordinating vehicle repairs.

### BACKGROUND

Vehicle repair facilities repair vehicles of many different makes and models for vehicles manufactured in many different years. When repairing a vehicle, a worker may repair or replace one or more parts of the vehicle (e.g., a quarter panel, a fender, a bumper, or another vehicle part) and may utilize one or more materials (e.g., adhesives, abrasives, paint, coatings, or other materials) when repairing or replacing the part. Utilizing the wrong materials or utilizing an incorrect quantity of material may result in a flawed repair, which may endanger occupants of the vehicle in the event of a collision. Unfortunately, tracking the materials used for any given vehicle repair can be very challenging. Moreover, the material and/or quantity of material used to repair or replace the part may be unknown prior to performing the vehicle repair, such that an accurate estimate of the material costs associated with the vehicle repair cannot be provided to the customer prior to actually performing the vehicle repair.

### SUMMARY

In general, this disclosure describes techniques for predicting materials to be used when performing a vehicle repair and certifying or confirming that the correct vehicle repair materials were used in the vehicle repair. A vehicle repair management system may predict a material and quantity of materials to be used when repairing or replacing a vehicle part. Examples of materials include adhesives, abrasives, paint, coatings, tools, among others. The vehicle repair management system utilizes current repair data and at least one of historical repair data or an existing repair specification to predict the materials to be used on a current vehicle repair and output the result in a predicted material repair plan (also referred to herein as “PMR plan”). The vehicle repair management system may customize the prediction based on historical repair data for a particular vehicle repair facility or a plurality of vehicle repair facilities. For example, the vehicle repair management system may customize the predicted material and/or quantity of materials based on a location of the vehicle repair facility, an age and/or mileage of the vehicle, a trim level of a vehicle, among other factors. Alternatively, or in addition to the historical repair date, the vehicle repair management system may customize the prediction based on existing repair specifications, such as an original equipment manufacturer (OEM) specification, a repair facility specification and/or a vehicle repair management system (VRMS) specification. In this way, the vehicle repair management system may more accurately determine the material and quantity of materials needed prior to performing the repair.

In at least one embodiment, the vehicle repair management system can be configured to provide the repair and/or a vehicle class into a machine learning model. From the machine learning model, the VRMS can receive a likelihood of the predicted quantity of the predicted material from the machine learning model. The VRMS can also provide the predicted quantity of the predicted material for a repair based on the likelihood.

The vehicle repair management system may also determine whether a repair was performed according to the PMR plan. For example, the vehicle repair management system may determine whether material actually used during the vehicle repair is the same as the material (e.g., same quantity and/or material) predicted to be used during the vehicle repair. The vehicle repair management system may perform various actions such as output an alert if the vehicle repair was not performed according to specification. In this way, the vehicle repair management system can achieve improved accountability associated with the vehicle repair and may increase the probability that a vehicle repair is performed according to specification, which may increase the safety of vehicle occupants and longevity of the vehicle.

The vehicle repair management system may also determine a cost of the vehicle repair including the time and cost of the materials used to repair or replace the vehicle part. The vehicle repair management system may further order materials based on the materials predicted to be used when repairing and/or replacing parts. In this way, the vehicle repair management system may more accurately estimate the cost to perform a vehicle repair and maintain inventory of materials used during vehicle repairs. The vehicle repair management system may improve the customer experience by increasing customer confidence in the price estimate and increasing the probability that the vehicle repair is performed timely (e.g., by reducing the risk of running out of materials while performing the vehicle repair).

The details of one or more embodiments of the disclosure are set forth in the accompanying drawings and the description below. Other features, objects, and advantages of the disclosure will be apparent from the description and drawings, and from the claims.

### BRIEF DESCRIPTION OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 is a block diagram illustrating an example system that includes a vehicle repair management system, in accordance with various techniques of this disclosure.

FIG. 3 is a block diagram illustrating, in detail, an operating perspective of the vehicle repair management system shown in FIG. 2.

FIG. 4 is a flowchart illustrating an example mode of operation for the vehicle repair management system, according to techniques described in this disclosure.

FIG. 5 is a block diagram illustrating an example mode of operation for the vehicle repair management system, according to techniques described in this disclosure.

### DETAILED DESCRIPTION

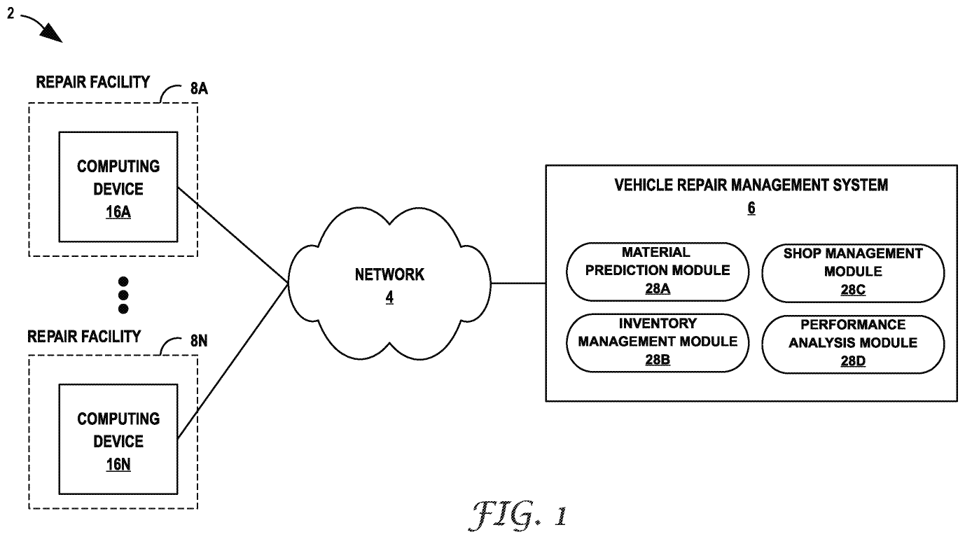

FIG. 1 is a block diagram illustrating an example system 2 that includes a vehicle repair management system for predicting materials to be used when performing a vehicle repair and for certifying or confirming that the correct vehicle repair materials were used in the vehicle repair. In the example of FIG. 1, system 2 includes a plurality of vehicle repair facilities 8A-8N (collectively, vehicle repair facilities 8), network 4, and vehicle repair management system (VRMS) 6.

Each of vehicle repair facilities 8 may represent a physical environment in which one or more individuals (also referred to as workers) perform vehicle repairs by repairing and/or replacing various vehicle parts utilizing various materials. Example materials used to perform vehicle repairs include adhesives, abrasives, tape, paint, coatings, and tools, among others.

Each of vehicle repair facilities 8 may include at least one computing device 16A-16N (collectively, computing devices 16). Examples of computing devices 16 include laptop computers, desktop computers, mobile computers (e.g., tablets, smartphones, smartwatches, etc.), and the like. Computing devices 16 may communicate with VRMS 6 via network 4. Network 4 represents any public or private communications network, for instance, cellular, Wi-Fi, and/or other types of networks, for transmitting data between computing systems, servers, and computing devices. Network 4 may include one or more network hubs, network switches, network routers, or any other network equipment, that are operatively inter-coupled and thereby provide for the exchange of information between computing devices 16 to one another and/or VRMS 6. Workers within vehicle repair facilities 8 may interface with VRMS 6 via computing devices 16 to prepare a set of materials for performing a vehicle repair, recording materials actually used during the vehicle repair, prepare cost estimates and invoices for the vehicle repair, order materials, etc.

In the example of FIG. 1, VRMS 6 includes material prediction module 28A, inventory management module 28B, shop management module 28C, and performance analysis module 28D. Material prediction module 28A predicts one or more materials to be used when performing a vehicle repair. The vehicle repair may include repairing and/or replacing one or more parts of the vehicle. Example parts of a vehicle include exterior components, interior components, structural components, mechanical components, among others. Examples of exterior components include exterior panels (e.g., a quarter panel, a fender, a bumper, a hood, a trunk lid, or other exterior component), windows, or any other components forming an exterior shell of the vehicle. Examples of interior components include seats, interior lights, an instrument panel, or any other component within the passenger compartment. Examples of structural components include a frame, a body, a body pillar, or other vehicle structures. Examples of mechanical components include an internal combustion engine, electric motor, brakes, batteries, suspension components (e.g., shocks, struts, axles, tie-rods, or other components) or any mechanical component located external to the passenger compartment.

In some examples, material prediction module 28A predicts or determines the materials to be used during the vehicle repair based on current repair data associated with the vehicle to be repaired and at least one of historical repair data or an existing repair specification. Historical repair data is typically associated with one or more vehicle repairs previously performed by one or more vehicle repair facilities 8. Existing repair specifications are repair protocols recommended by a source (e.g., vehicle manufacturer, repair shop, etc.) and include OEM specifications, repair facility specifications and/or a VRMS specifications. It should be understood that existing repair specifications could be based in part or in whole on historical repair data and/or, over time, may become historical repair data.

For each vehicle repair, the repair data may include vehicle data, task data, entity data, or a combination thereof. Vehicle data may include data indicating characteristics of the vehicle, such as a type of the vehicle (e.g., a make, a model, a trim package, and/or a model year), a vehicle identification number (VIN) of the vehicle, a mileage of the vehicle, a location of the vehicle (e.g., a geographic region in which the vehicle is used or an address at which the vehicle is typically stored/parked), local selection of repair information, repair entity quality, or a combination thereof. A vehicle VIN may include data indicative of characteristics of the vehicle, such as a make, model, trim level, color, model year, or other characteristics of the vehicle. Task data may include data indicative of a vehicle repair, such as data indicating a type of vehicle repair, materials used during the repair, quantities of materials used, a duration of the repair (e.g., an amount of time a worker took to perform the repair), a physical measurement of the part or a portion of the part to be repaired or replaced, etc. Entity data includes data associated with an entity performing the vehicle repair, such as data indicating a geographic location of the entity performing the repair, a name of an entity performing the repair, among others. The entity performing the repair may include the individual worker performing the repair, an individual repair facility, and/or a collection of repair facilities (e.g., a company that owns and/or operates a plurality of repair facilities). In one example, material prediction module 28A receives current repair data (e.g., current vehicle data and current task data) for the vehicle to be repaired, such as data indicating a type of a vehicle to be repaired and a type of a vehicle repair to be performed. For example, computing device 16A may receive a user input from a worker within vehicle repair facility 8A indicating the type of vehicle and the type of the vehicle repair to be performed, and may send the data to VRMS 6.

In some examples, material prediction module 28A determines the material to be used during the vehicle repair based at least in part on the historical repair data and the current repair data associated with a vehicle to be repaired. In one example, material prediction module 28A may query the historical repair data to identify historical repairs that are similar to the vehicle repair to be performed. For example, material prediction module 28A may identify similar historical repairs as the repair to be performed and predict materials to be used during the pending repair based on the materials used during the similar historical repairs.

In some examples, a historical repair may be considered similar to a pending repair when the repair is performed by a similar entity. In such examples, material prediction module 28A may predict materials for the pending repair based on materials for historical repairs involving the same entity. For example, when the pending vehicle repair includes replacing a particular external component (e.g., an external panel, such as a quarter panel), material prediction module 28A may predict the materials to be used to replace the external component to include a particular type of adhesive. In another example, when a different entity performs a similar vehicle repair, material prediction module 28A may predict the materials to be used to replace the external component to include a different type of adhesive. In this way, material prediction module 28A may customize the prediction for different entities based on historical repair data for the various entities.

In another example, a historical repair may be considered similar to a vehicle repair to be performed (also referred to as a pending repair) when the historical repair and the pending repair each involve repairing or replacing the same part on a similar type (e.g., make and model) of vehicle. For example, material prediction module 28A may identify similar historical repairs that involve replacing or repairing similar parts. In such examples, material prediction module 28A may predict materials for the pending repair based on materials for historical repairs involving the same or similar parts.

In some scenarios, a historical repair may be considered similar to a pending repair when the historical repair and the pending repair each involve the same type (e.g., same make, model, and/or trim) of vehicle. That is, in some examples, material prediction module 28A determines the material to be used during the pending vehicle repair based at least in part on a type of the vehicle to be repaired and historical repairs involving the same type of vehicle. In one instance, when the pending vehicle repair includes repairing a scratch in an exterior paint and the type of the vehicle includes a trim level of the vehicle (e.g., a base trim level that includes a basic exterior paint), material prediction module 28A may determine the material to be used for the repair includes one material (e.g., a particular coating to cover the paint). In another instance, when the type of the vehicle includes a different trim level (e.g., a premium trim that includes a different exterior paint), material prediction module 28A may determine the material includes a different material (e.g., a different coating, such as a coating better suited to adhere to the different paint).

In some examples, material prediction module 28A determines the material to be used during the vehicle repair based at least in part on an existing repair specification and the current repair data associated with a vehicle to be repaired. The existing repair specification may be a repair protocol recommended by the vehicle manufacturer, a particular repair facility or the vehicle repair management system.

In some examples, material prediction module 28A determines the material to be used during the vehicle repair based on the current repair data, the historical data, and an existing repair specification.

In some examples, material prediction module 28A predicts a quantity of the material to be used during the pending vehicle repair. Material prediction module 28A may predict a quantity of the material to be used during the pending vehicle repair based on current repair data and at least one of historical data or existing repair specifications (e.g., historical and current vehicle data, task data, and/or entity data). For example, material prediction module 28A may determine an average quantity of material used by a particular entity to perform repairs similar to the pending repair based on the historical repair data. In at least one embodiment, instead of average quantity of material, the material prediction module 28A can enable the use of a selected value of the predicted material that is based on a weighted value of the predicted material used at the plurality of entities based on their quality metric (e.g., a quality score). By using a weighted value, this could avoid skew in the data due to mistakes, and would grant increased credibility and preference to the shops which have higher quality metrics.

In some examples, material prediction module 28A outputs data indicating the predicted material (and optionally, data indicating the predicted quantity of the predicted material). In one example, material prediction module 28A outputs data indicating each of the predicted materials to computing device 16A. Computing device 16A may receive the data indicating the predicted material and may output a graphical user interface (GUI) that includes the data indicating the predicted materials (e.g., via a display device) and/or output audio data indicating the predicted materials (e.g., via a speaker).

In some examples, material prediction module 28A may compare the predicted material and/or quantity in the PMR plan to the materials and/or quantifies in an existing repair specification. For example, the predicted material and/or quantity may be based upon current repair data and, at least in part, historical repair data. The material prediction module 28A may then determine whether the predicted material includes an OEM (also referred to as “manufacturer”) specified material and/or the predicted quantity is within a threshold quantity of a manufacturer specified quantity. When the predicted material and/or quantity corresponds to the manufacturer specification (e.g., the predicted material includes the manufacturer specified material), material prediction module 28A may output data (e.g., a graphical user interface) indicating the predicted materials and/or quantity comply with a manufacturer specified material. When the predicted material and/or quantity does not correspond to the manufacturer specification, material prediction module 28A may output data indicating the predicted materials and/or quantity do not correspond to the manufacturer specified material.

In some examples, upon completion of a vehicle repair, inventory management module 28B determines whether the vehicle repair was performed according to the PMR plan generated by the material predication module 28A. The inventory management module 28B receives data indicating an actual material used during the vehicle repair. For example, a worker within vehicle repair facility 8A may enter the materials and/or quantity of materials used during the repair. In another example, computing device 16A may determine the materials used, for example, by scanning a barcode or RFID tag on a material, or identifying the material via image recognition, among other techniques. The inventory management module 28B then uses the actual materials to verify that the repair was completed according to the PMR plan generated by the material predication module 28A. For example, the inventory management module 28B can compare the actual materials used to complete the repair with the predicted materials from the PMR plan and either determine the vehicle was repaired according to the PMR plan or determine the vehicle was not repaired according to the PMR plan.

Inventory management module 28B may determine whether the vehicle repair was performed according to the PMR plan by determining whether the actual quantity of material used during the vehicle repair is within a threshold of a quantity defined by the PMR plan. In one example, inventory management module 28B receives user input indicating the quantity of material actually used during the repair. In one example, computing device 16A determines the quantity of material actually used. For example, computing device 16A may determine a quantity of materials actually used by weighing the material or performing image recognition to identify a quantity of material in a package prior to the material being used and again after the material was used. The inventory management module 28B then uses the actual quantity of materials to verify that the repair was completed according to the PMR plan generated by the material predication module 28A. For example, the inventory management module 28B can compare the actual quantities used to complete the repair with the predicted quantities from the PMR plan and either determine the vehicle was repaired according to the PMR plan or determine the vehicle was not repaired according to the PMR plan.

Inventory management module 28B may output a notification indicating whether the repair was performed according to the PMR plan. For example, inventory management module 28B may output the notification to a worker within vehicle repair facility 8A, a supervisor of the worker, an insurance company, and/or an owner of the vehicle indicating whether the vehicle repair was performed according to the PMR plan. In this way, inventory management module 28B may alert the worker, supervisor, insurance company, and/or owner that the repair needs to be re-evaluated or redone or may certify that the vehicle repair is complete and performed correctly.

In some examples, inventory management module 28B automatically maintains inventory levels based on least in part on the predicted materials and predicted quantity of materials. In one example, inventory management module 28B may determine whether vehicle repair facility 8A includes the predicted materials and predicted quantity of materials prior to a worker performing the vehicle repair. For example, inventory management module 28B may store data indicating the current materials and current quantity of materials currently located within vehicle repair facility 8A, and may compare current quantity of the predicted materials to the predicted quantity to determine whether vehicle repair facility 8A includes enough of the predicted materials to complete the vehicle repair. Inventory management module 28B may automatically generate an order for additional materials in response to determining the current quantity of the predicted material is less than the predicted quantity. In another example, inventory management module 28B may output a notification (e.g., to computing device 16A) in order to alert a worker that repair facility 8A may not include sufficient materials to perform the vehicle repair. Inventory management module 28B may automatically maintain inventory levels based at least in part on the actual materials and actual quantity of materials used during the vehicle repair. For example, inventory management module 28B may automatically generate an order for additional materials to replace the actual quantity of materials used during the vehicle repair.

Shop management module 28C may generate invoices based on the predicted materials and/or the actual materials used during the vehicle repair. In one example, shop management module 28C determines an estimated invoice based on the predicted materials and the predicted quantity of predicated materials. Similarly, shop management module 28C may determine an actual invoice based on the actual materials and the actual quantity of materials used during the vehicle repair. Shop management module 28C may output the estimated invoice and/or actual invoice, for example, to an insurance company and/or owner of the vehicle. By determining the materials to be used for the vehicle repair prior to actually performing the vehicle repair, shop management module 28C may provide a more accurate estimated invoice.

Performance analysis module 28D may evaluate the performance of one or more entities that perform vehicle repairs. In some examples, performance analysis module 28D may determine various performance metrics for each entity, such as the average amount of time to perform a vehicle repair, an average actual quantity of materials used for the vehicle repair, etc. Performance analysis module 28D may compare performance metrics across entities. For example, performance analysis module 28D may compare the average quantity of material used for a first entity (e.g. a first worker or a first repair facility) to the average quantity of material used by a plurality of entities (e.g., all workers within a given repair facility, all repair facilities) for the same type of vehicle repair. Performance analysis module 28D may generate reports based on the performance metrics. In some examples, performance analysis module 28D may identify performance outliers, such as entities whose metrics are at least a threshold difference from an average metric (e.g., at least one standard deviation above or below the average of all entities).

Performance analysis module 28D may generate a performance improvement list, for example, by identifying entities that perform vehicle repairs with relatively low performance. For example, performance analysis module 28D may identify entities that take longer than a threshold amount of time, use too little or too much material, use the wrong materials. In other examples, the performance improvement list may indicate entities that perform one or more types of repairs with relatively low performance.

In some scenarios, performance analysis module 28D may generate one or more dashboards, such as a profit dashboard, a sales dashboard, etc. For example, performance analysis module 28D may track the cost of the actual materials and actual quantity of actual materials used to perform vehicle repairs, the time to perform the actual repairs, a quantity of repairs performed, etc. for each entity. In this way, performance analysis module 28D may provide insights into the performance of various entities, and may enable a user of VRMS 6 to more easily understand the performance of individual entities and the relative performance of individual entities or groups of entities relative to a larger group of entities.

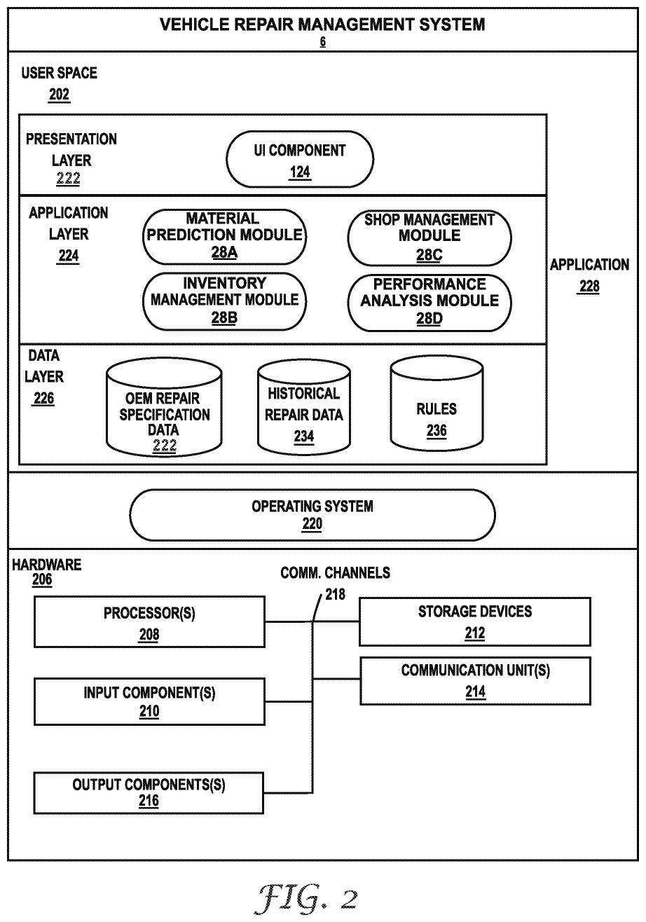

FIG. 2 is a block diagram providing an operating perspective of VRMS 6, in accordance with techniques described herein. FIG. 2 illustrates only one example of VRMS 6. Many other examples of VRMS 6 may be used in other instances and may include a subset of the components included in example VRMS 6 or may include additional components not shown in example VRMS 6 in FIG. 2.

In at least one embodiment, VRMS 6 can be run on a computer having one or more processors.

As shown in the example of FIG. 2, VRMS 6 may be logically divided into user space 202, kernel space 204, and hardware 206. Hardware 206 may include one or more hardware components that provide an operating environment for components executing in user space 202 and kernel space 204. User space 202 and kernel space 204 may represent different sections or segmentations of memory, where kernel space 204 provides higher privileges to processes and threads than user space 202. For instance, kernel space 204 may include operating system 220, which operates with higher privileges than components executing in user space 202.

As shown in FIG. 2, hardware 206 includes one or more processors 208, input components 210, storage devices 212, communication units 214, and output components 216. Processors 208, input components 210, storage devices 212, communication units 214, and output components 216 may each be interconnected by one or more communication channels 218. Communication channels 218 may interconnect each of the components 208, 210, 212, 214, and 216 and other components for inter-component communications (physically, communicatively, and/or operatively). In some examples, communication channels 218 may include a hardware bus, a network connection, one or more inter-process communication data structures, or any other components for communicating data between hardware and/or software.

One or more processors 208 may implement functionality and/or execute instructions within VRMS 6. For example, processors 208 of VRMS 6 may receive and execute instructions stored by storage devices 212 that provide the functionality of components included in kernel space 204 and user space 202. These instructions executed by processors 208 may cause VRMS 6 to store and/or modify information, within storage devices 212 during program execution. Processors 208 may execute instructions of components in kernel space 204 and user space 202 to perform one or more operations in accordance with techniques of this disclosure. That is, components included in user space 202 and kernel space 204 may be operable by processors 208 to perform various functions described herein.

One or more input components 210 of VRMS 6 may receive input. Examples of input are tactile, audio, kinetic, and optical input, to name only a few examples. Input components 210 of VRMS 6, in one example, include a voice responsive system, video camera, buttons, control pad, microphone or any other type of device for detecting input from a human or machine. In some examples, input component 210 may be a presence-sensitive input component, which may include a presence-sensitive screen, touch-sensitive screen, etc.

One or more communication units 214 of VRMS 6 may communicate with external devices by transmitting and/or receiving data. For example, VRMS 6 may use communication units 214 to transmit and/or receive radio signals on a radio network such as a cellular radio network. Examples of communication units 214 include an optical transceiver, a radio frequency transceiver, a GPS receiver, or any other type of device that can send and/or receive information. Other examples of communication units 214 may include Bluetooth®, GPS, 3G, 4G, 5G and Wi-Fi® radios found in computing devices as well as Universal Serial Bus (USB) controllers and the like.

One or more output components 216 of VRMS 6 may generate output. Examples of output are tactile, audio, and video output. Output components 216 of VRMS 6, in some examples, include a presence-sensitive screen, sound card, video graphics adapter card, speaker, cathode ray tube (CRT) monitor, liquid crystal display (LCD), or any other type of device for generating output to a human or machine. Output components may include display components such as a liquid crystal display (LCD), a Light-Emitting Diode (LED) or any other type of device for generating tactile, audio, and/or visual output. Output components 216 may be integrated with VRMS 6 in some examples.

In other examples, output components 216 may be physically external to and separate from VRMS 6 but may be operably coupled to VRMS 6 via wired or wireless communication. An output component may be a built-in component of VRMS 6 located within and physically connected to the external packaging of VRMS 6 (e.g., a screen on a mobile phone). In another example, a presence-sensitive display may be an external component of VRMS 6 located outside and physically separated from the packaging of VRMS 6 (e.g., a monitor, a projector, etc. that shares a wired and/or wireless data path with a tablet computer).

One or more storage devices 212 within VRMS 6 may store information for processing during operation of VRMS 6. In some examples, storage device 212 is a temporary memory, meaning that a primary purpose of storage device 212 is not long-term storage. Storage devices 212 on VRMS 6 may configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art.

Storage devices 212, in some examples, also include one or more computer-readable storage media. Storage devices 212 may be configured to store larger amounts of information than volatile memory. Storage devices 212 may further be configured for long-term storage of information as non-volatile memory space and retain information after activate/off cycles. Examples of non-volatile memories include magnetic hard discs, optical discs, floppy discs, flash memories, or forms of electrically programmable memories (EPROM) or electrically erasable and programmable (EEPROM) memories. Storage devices 212 may store program instructions and/or data associated with components included in user space 202 and/or kernel space 204.

As shown in FIG. 2, application 228 executes in user space 202 of VRMS 6. Application 228 may be logically divided into presentation layer 222, application layer 224, and data layer 226. Presentation layer 222 may include user interface (UI) component 124, which generates and renders user interfaces of application 228. Application 228 may include, but is not limited to: UI component 124, material predication module 28A, inventory management module 28B, shop management module 28C, and performance analysis module 28D. For instance, application layer 224 may include material predication module 28A, inventory management module 28B, shop management module 28C, and performance analysis module 28D.

Data layer 226 may include one or more datastores. A datastore may store data in structure or unstructured form. Example datastores may be any one or more of a relational database management system, online analytical processing database, table, or any other suitable structure for storing data. In some examples, data layer 226 includes existing repair specifications 232, historical repair data 234, and rules 236. Existing repair specification 232 may include data indicating materials (and optionally, quantities of materials) recommend by various sources (e.g., OEM's, repair facilities, and the vehicle repair management system) for the various vehicle repairs. Historical repair data 234 includes vehicle data, task data, and/or entity data for a plurality of historical vehicle repairs.

According to techniques of this disclosure, material prediction module 28A predicts one or more materials and/or quantities of predicted material to be used when performing a vehicle repair based on current repair data and at least one of historical repair data 234 or existing repair specifications 232. For example, in some instances, the material prediction module may apply current repair data associated with the vehicle to be repaired to one or more rules 236 to predict the materials and/or quantity of materials to be used during a pending repair. The rules 236 may be pre-defined. In some example, however, the rules 236 may be generated using machine learning. Example machine learning techniques that may be employed to generate performance rules 236 can include various learning styles, such as supervised learning, unsupervised learning, and semi-supervised learning. Example types of algorithms include clustering algorithms or similarity algorithms. Additional types of algorithms include Bayesian algorithms, decision-tree algorithms, regularization algorithms, regression algorithms, instance-based algorithms, artificial neural network algorithms, deep learning algorithms, dimensionality reduction algorithms and the like. Various examples of specific algorithms include Bayesian Linear Regression, Boosted Decision Tree Regression, and Neural Network Regression, Back Propagation Neural Networks, the Apriori algorithm, K-Means Clustering, k-Nearest Neighbor (kNN), Learning Vector Quantization (LVQ), Self-Organizing Map (SOM), Locally Weighted Learning (LWL), Ridge Regression, Least Absolute Shrinkage and Selection Operator (LASSO), Elastic Net, and Least-Angle Regression (LARS), Principal Component Analysis (PCA) and Principal Component Regression (PCR).

In other instances, the material prediction module 28A may query historical repair data 234 to identify historical repairs performed by an entity associated with vehicle repair facility 8A that involved a similar repair and predict the materials to be used for the current vehicle repair based upon materials used for similar historical repairs by the same entity.

In yet other instances, the vehicle to be repaired may comprise a new model year and historical repair data 234 includes data for one or more previous model years of a vehicle but does not include data for the new model year. In such instances, material prediction module 28A may determine materials used to perform the pending vehicle repair based on historical repair data for repairs performed on prior years models, such as the most recent year prior to the new model year. In some examples, the vehicle to be repaired includes a new model of vehicle. In such examples, material prediction module 28A may determine the materials for the pending repair based on historical repair data for repairs performed on similar models (e.g., vehicle models by the same manufacturer or vehicle models of a similar size by other manufacturers).

In some scenarios, material prediction module 28A predicts one or more materials to be used when performing a vehicle repair based at least in part on current repair data (e.g., vehicle data, task data, and/or entity data) associated with a vehicle to be repaired during a pending repair. In some examples, the current vehicle data for the vehicle to be repaired includes a location of the vehicle (e.g., a geographic region in which the vehicle is used). In one example, when the location of the vehicle includes relatively high levels of salt (e.g., near an ocean or a snowy region where salt is used on roads), material prediction module 28A may determine the materials to be used during the pending vehicle repair includes an anti-corrosion coating. In another example, when the location of the vehicle is relatively arid or is a non-saline location, material prediction module 28A may determine the materials to be used during the pending vehicle repair do not include anti-corrosion coating. Additionally or alternatively, in some instances, material prediction module 28A determines the material to be used during the pending vehicle repair based at least in part on a mileage of the vehicle to be repaired, a VIN of the vehicle, and/or a trim level of the vehicle.

In some examples, material prediction module 28A predicts a quantity of the material to be used during the pending vehicle repair. Material prediction module 28A may predict a quantity of the material to be used during the pending vehicle repair based on vehicle data, task data, and/or entity data associated with the vehicle to be repaired. In some examples, the task data includes data indicating a physical measurement of the part to be repaired or replaced. In an example where the vehicle repair includes repairing cracked glass (e.g., a windshield), material prediction module 28A may determine the material for the repair includes a resin to fill the crack and may predict a quantity of the material based on a length of the crack. As another example, when the vehicle repair includes replacing a bumper, material prediction module 28A may determine the material includes an adhesive to attach the replacement bumper and may determine a quantity of adhesive based on a size of the bumper.

In one example, material prediction module 28A predicts the quantity of material to be used based additionally, or alternatively, on historical repair data 234. For example, historical repair data 234 may indicate that different entities (e.g., repair facilities) utilize different amounts of material (e.g., adhesive) even when performing similar repairs (e.g., different repair facilities may apply materials more abundantly than others). In such examples, material prediction module 28A may predict the quantity of adhesive is one amount when one entity (e.g., a first repair facility) performs the repair and a different amount when another entity performs the repair.

In another example, the material predication module 28A predicts the quantify of material to be used based additionally, or alternatively, on existing repair specifications, such as OEM, repair facility and vehicle repair management specifications.

In some examples, material prediction module 28A outputs data indicating the predicted material (and optionally, data indicating the predicted quantity of the predicted material). In one example, material prediction module 28A outputs data indicating each of the predicted materials to computing device 16A of FIG. 1. Computing device 16A may receive the data indicating the predicted material and may output a graphical user interface (GUI) that includes the data indicating the predicted materials (e.g., via a display device) and/or output audio data indicating the predicted materials (e.g., via a speaker).

Material prediction module 28A may determine whether the predicted material and/or quantity complies with an OEM specification. For example, material prediction module 28A may determine whether the predicted material includes a manufacturer specified material and/or the predicted quantity is within a threshold quantity of a manufacturer specified quantity. Material prediction module 28A may query existing repair specification 232 to determine the manufacturer specified materials and manufacturer specified quantity of materials for a given repair and compare to the predicted material and predicted quantity of the predicted material. In one instance, material prediction module 28A outputs data (e.g., a notification) to another computing device (e.g., computing device 16A) indicating whether the predicted materials, predicted quantity, or both, comply with a manufacturer specified material and quantity.

Inventory management module 28B may determine whether the vehicle repair was performed according to the PMR plan. The PMR plan may include data indicating materials (and optionally, quantities of materials) specified by the material prediction module 28A. Inventory management module 28B may determine the vehicle repair was not performed according to plan in response to determining that the actual material used does not include a material defined by the PMR plan and/or that the actual quantity of material used is not within the threshold of the quantity specified by the PMR plan. In one example, inventory management module 28B may determine that the vehicle repair was performed according to plan in response to determining that the actual material used includes the material defined by the PMR plan and/or that the actual quantity of material used is within the threshold of the quantity defined by the PMR plan. Inventory management module 28B may output a notification indicating whether the repair was performed according to the PMR plan. For example, inventory management module 28B may output the notification to a worker within vehicle repair facility 8A, a supervisor of the worker, an insurance company, and/or an owner of the vehicle indicating whether the vehicle repair was performed according to the PMR plan. In examples where the vehicle owner and/or vehicle repair facility receives a notification indicating that the vehicle repair was performed according to the PMR plan, the owner and/or repair facility may use such notifications as documentation that the repair was performed correctly (e.g., enabling the vehicle to be included as a certified pre-owned vehicle upon re-sale).

Inventory management module 28B may automatically maintain inventory levels based on least in part on the predicted materials, the predicted quantity of predicted materials, the actual materials used during the repair, the actual quantity of actual materials used during the repair, or a combination thereof. For instance, inventory management module 28B may generate an order for additional materials in response to determining that the current quantity of the predicted materials is less than the predicted quantity to be used during the pending repair. In another example, inventory management module 28B may automatically generate an order for additional materials in response to determining the actual quantity of the material used is greater than the predicted quantity (e.g., which may indicate repair facility 8A should re-stock).

Shop management module 28C may generate invoices based on the predicted materials and/or the actual materials used during the vehicle repair. In one example, shop management module 28C determines an estimated invoice based on the predicted materials and the predicted quantity of predicated materials. Similarly, shop management module 28C may determines an actual invoice based on the actual materials and the actual quantity of materials used during the vehicle repair. Shop management module 28C may output the estimated invoice and/or actual invoice, for example, to an insurance company and/or owner of the vehicle. By determining the materials to be used for the vehicle repair prior to actually performing the vehicle repair, shop management module 28C may provide a more accurate estimated invoice.

Performance analysis module 28D may evaluate the performance of one or more entities that perform vehicle repairs. In some examples, performance analysis module 28D may determine various performance metrics for a plurality of entities based on historical repair data 234, such as performance metrics for each worker within one or more repair facilities, performance metrics for individual repair facilities, and/or performance metrics for a group of associated repair facilities (e.g., repair facilities owned by the same company). In one example, performance analysis module 28D determines performance metrics for different repairs and/or different types of vehicles.

According to some scenarios, performance analysis module 28D determines an aggregate performance metric for a plurality of entities. Examples of aggregate performance metrics include an average amount of time to complete a repair, an average quantity of material used during the repair. In one scenario, performance analysis module 28D outputs data indicating an aggregate performance metric relative to an expected metric and/or actual metric. For example, performance analysis module 28D may output a graphical user interface indicating an average quantity of a material used for a particular vehicle repair and a predicted quantity (or actual quantity) of material for the vehicle repair. In this way, performance analysis module 28D may enable a user of VRMS 6 to quickly see the how an entity is predicted to perform (or actually performs) relative to a plurality of different entities.

Performance analysis module 28D may compare performance metrics across entities. For example, performance analysis module 28D may compare the average quantity of material used for a first entity (e.g. a first worker or a first repair facility) to the average quantity of material used by a plurality of entities (e.g., all workers within a given repair facility, all repair facilities) for the same type of vehicle repair. Performance analysis module 28D may generate reports based on the performance metrics. In some examples, performance analysis module 28D may identify performance outliers, such as entities whose metrics are at least a threshold difference from an average metric (e.g., at least one standard deviation above or below the average of all entities).

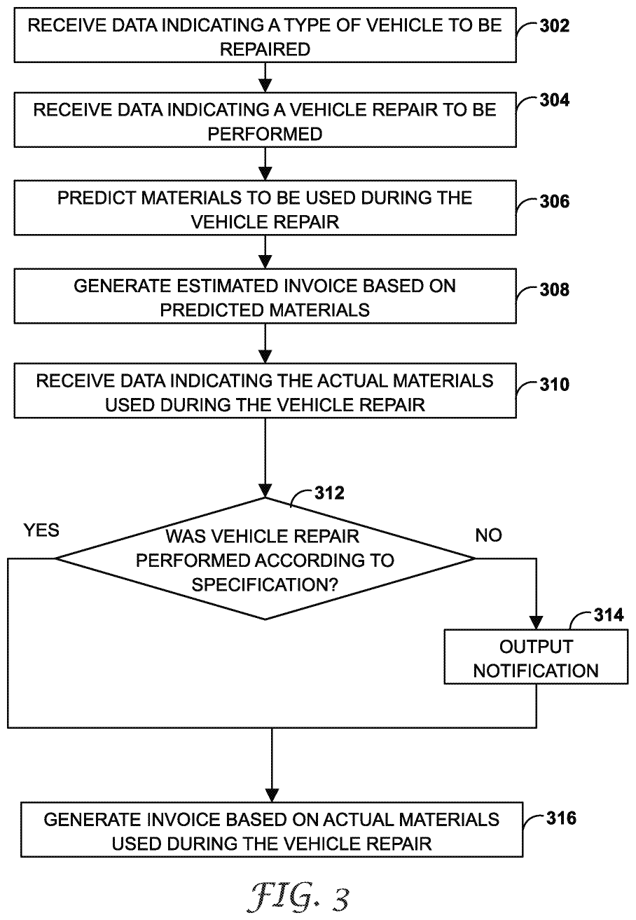

FIG. 3 is a flowchart illustrating an example mode of operation for a vehicle repair management system, according to techniques described in this disclosure. FIG. 3 is described with reference to vehicle repair management system 6 as described in FIGS. 1 and 2.

Material prediction module 28A may receive current repair data associated with a vehicle to be repaired, such as vehicle data for the vehicle, task data for the repair to be performed, entity data for an entity performing the repair, or a combination thereof. In one example, material prediction module 28A receives vehicle data indicating a type (e.g., make or model) of vehicle to be repaired (302). In some examples, the vehicle data includes data indicates a mileage of the vehicle, a trim level of the vehicle, a geographic location of the vehicle among others.

Material prediction module 28A receives task data indicating a vehicle repair to be performed (304). In one example, the task data includes data indicating at least one of a type of vehicle repair to be performed or a physical measurement of the part or a portion of the part to be repaired or replaced.

In the example of FIG. 3, material prediction module 28A predicts one or more materials to be used during the vehicle repair (306). Material prediction module 28A may predict the materials used during the vehicle repair based on current repair data and at least one of historical repair data or an existing repair specification. In some examples, material prediction module 28A predicts a quantity of the material to be used during the vehicle repair. For example, material prediction module 28A may predict the materials and/or quantity of predicted materials by applying the data associated with the vehicle to one or more rules. The rules may be trained via machine learning, for example, using historical repair data 234.

In some examples, shop management module 28C generates an estimated invoice based on the predicted materials (308). The estimated invoice may include an estimated materials cost, an estimated labor cost, or both. In one example, shop management module 28C may multiply each material by the cost of the material to generate an estimated materials cost. In one example, shop management module also determines the estimated materials cost based on a predicted quantity of the predicted material (e.g., a partial container of adhesive, coating, etc.). Shop management module 28C generates the estimated labor cost by multiplying an estimated duration of the repair by a labor cost.

In at least one embodiment, the PMR plan can be determined/generated from the predicted materials and quantities thereof in block 308. Based on the PMR plan being determined, the VRMS 6 can be configured to perform at least one action.

For example, various actions can be performed by the VRMS 6 within or before block 312. For example, the action by the VRMS 6 can include further determining whether the predicted material includes the actual material; and output data indicating whether the vehicle repair was performed according to the PMR plan to a machine learning algorithm in block 314. In another example, the VRMS 6 can determine whether the actual quantity of the actual material is within a threshold of the predicted quantity of the PMR plan prior to the outputting of data in block 314.

In another example, the VRMS 6 can communicate the PMR plan to a user as an action. In another example, the VRMS 6 can determine a manufacturer specified material to be used during the vehicle repair, and determine whether the predicted material to be used includes the manufacturer specified material. If the predicted material to be used does include the manufacturer specified material, then the VRMS 6 can output data indicating whether the predicted material to be used includes the manufacturer specified material in block 314. The outputted data can be provided to a third-party such as an insurance company, or automotive company to verify that the repair was performed to specification. In at least one embodiment, the data can be output to an internal record or notification system rather than a third-party.

In at least one embodiment, the recorded information about the conformance of the actual material used compared to the predicted material compared to the manufacturer-specified material is so that the shop can support their use of the material with evidence. In the event of a subsequent damage to the vehicle, perhaps with unexpected damage to vehicle and person, questions could arise about adequacy of the previous repair. This could be a liability-management mechanism for the shop who did the first repair if they can prove that it was done properly, with the correct materials and amount of material, and procedure.

Inventory management module 28B determines, in some scenarios, whether the vehicle repair was performed according to a PMR plan (312). In some examples, inventory management module 28B receives data indicating an actual material used during the vehicle repair 310. Optionally, inventory management module 28B may receive data indicating the actual quantity of materials used during the vehicle repair. For example, a worker within vehicle repair facility 8A may enter the materials and/or quantity of materials used during the repair. In another example, computing device 16A may determine the materials used and/or quantity of materials used. For example, computing device 16A may determine the materials used by scanning a barcode or RFID tag on a material, or identifying the material via image recognition, among other techniques. In one example, computing device 16 determines a quantity of materials actually used by weighing the material or performing image recognition to identify a quantity of material in a package (e.g., the quantity prior to the material being used and/or after the material was used).

In at least one embodiment, the inventory management module 28B can use the actual materials used to retrain the machine learning model.

Inventory management module 28B may determine the vehicle repair was not performed according to plan in response to determining that the actual material used does not include a material defined by the PMR plan and/or that the actual quantity of material used is not within the threshold of the quantity specified by the PMR plan. Responsive to determining that the vehicle repair was not performed according to the PMR plan (“NO” path of 312), inventory management module 28B may output a notification indicating the vehicle repair was not performed according to the PMR plan (314). For example, inventory management module 28B may send the notification to computing device 16A to alert a worker within repair facility 8A that the vehicle repair was not performed correctly. Additionally or alternatively, inventory management module 28B may send the notification to an owner of the vehicle, an insurance company, or both.

In some examples, inventory management module 28B may determine that the vehicle repair was performed according to specification (“YES” path of 312) in response to determining that the actual material used includes the material defined by the PMR plan and/or that the actual quantity of material used is within the threshold of the quantity defined by the PMR plan. Responsive to determining that the vehicle repair was performed according to the PMR plan, inventory management module 28B may output a notification indicating the repair was performed correctly (e.g., to computing device 16A, the owner of the vehicle, an insurance company, or a combination thereof).

In some examples, shop management module 28C generates an actual or final invoice based on the actual materials used during the vehicle repair (316). The actual invoice may include an actual materials cost, an actual labor cost, or both. Shop management module 28C may determine the actual materials and/or actual labor cost in a manner similar to determining the estimated materials cost and estimated labor cost.

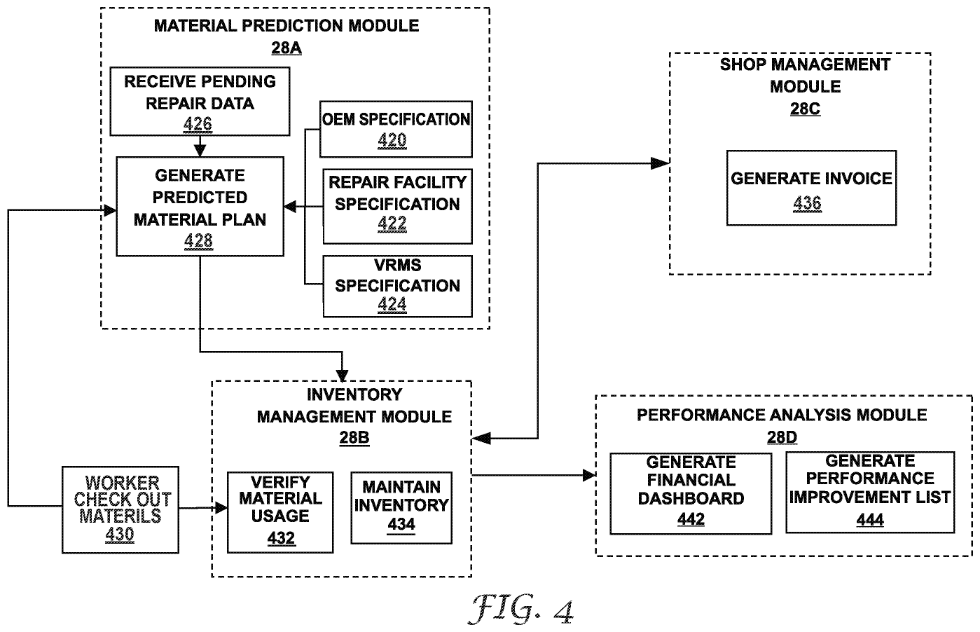

FIG. 4 is a flowchart illustrating another example mode of operation for a vehicle repair management system, according to techniques described in this disclosure. FIG. 4 is described with reference to vehicle repair management system 6 as described in FIGS. 1 and 2.

Repair facility 8A may receive a vehicle for a vehicle repair. Computing device 16A of repair facility 8A may send current repair data to VRMS 6. Material prediction module 28A receives the current repair data (426). The current repair data may include vehicle data for the vehicle to be repaired, task data for the repair to be performed, entity data for the entity performing the vehicle repair, or a combination thereof.

Material prediction module 28A generates a PMR plan by predicting one or more materials to be used during the repair (and optionally, a quantity of material) (428). For example, material prediction module 28A may predict the materials and quantity of materials based on at least one of historical repair data 418, OEM specification 420, repair facility specification 422, or VRMS specification 424. OEM specification 420 may include data indicating materials (and optionally, quantities of materials) specified by the OEM for various repairs of various vehicles. Similarly, repair facility specification 422 may include data indicating materials (and optionally, quantities of materials) specified by the repair facility performing the vehicle repair. VRMS specification 424 may include data indicating materials (and optionally, quantities of materials) specified by VRMS 6 for various repairs. In some examples, VRMS specification 424 includes rules 236 of FIG. 2, such as one or more machine trained models (e.g., trained based on historical repair data 234). Material prediction module 28A may output data indicating the predicted material (and optionally, data indicating the predicted quantity of the predicted material), for example, to a computing device 16A to enable a worker of repair facility 8A to prepare the predicted materials.

A worker of repair facility 8A may check-out materials (430) or prepare the predicted materials based on the PMR plan (428). For example, the worker may review a list of predicted materials (and optionally, quantity of predicted materials) and gather the materials. The worker may then perform the vehicle repair using all or a portion of the predicted materials. In some examples, the worker utilizes materials included in the PMR plan and/or different quantities of materials than predicted in the PMR plan. In one example, computing device 16A receives user input from the worker specifying actual materials and/or actual quantity of materials used during the vehicle repair. In another example, computing device 16A automatically determines the actual materials and/or actual quantity of materials used during the vehicle repair.

Inventory management module 28B may verify the actual material usage (432). For example, Inventory management module 28B may determine whether the vehicle repair was performed according to the PMR plan. Inventory management module 28B may determine whether the vehicle repair was performed according to the PMR plan by determining whether the actual material used to perform the vehicle repair includes the predicted material and/or whether the actual quantity of the actual material used during the vehicle repair is within a threshold of a quantity defined by the PMR plan.

In some examples, inventory management module 28B automatically maintains inventory (434) based on least in part on the predicted materials, the predicted quantity of predicted materials, the actual materials, and/or the actual quantity of actual materials used to perform the repair. For example, inventory management module 28B may store data indicating the current materials and current quantity of materials currently located within vehicle repair facility 8A. Inventory management module 28B may compare current quantity of the predicted materials to the predicted quantity to determine whether vehicle repair facility 8A includes enough of the predicted materials to complete the vehicle repair. Inventory management module 28B may automatically generate an order for additional materials in response to determining the current quantity of the predicted material is less than the predicted quantity. Similarly, inventory management module 28B may automatically generate an order for additional materials to replace the actual quantity of materials used during the vehicle repair.

Shop management module 28C may generate invoices (436) based on the predicted materials and/or the actual materials used during the vehicle repair. In one example, shop management module 28C determines an estimated invoice based on the predicted materials and the predicted quantity of predicated materials. Similarly, shop management module 28C may determines an actual invoice based on the actual materials and the actual quantity of materials used during the vehicle repair. Shop management module 28C may output the estimated invoice and/or actual invoice, for example, to an insurance company and/or owner of the vehicle.

Performance analysis module 28D may a generate financial dashboard (442). The financial dashboard may include a profit dashboard, a sales dashboard, etc. For example, performance analysis module 28D may track the cost of the actual materials and actual quantity of actual materials used to perform vehicle repairs, the time to perform the actual repairs, a quantity of repairs performed, etc. for each entity.

In some instances, performance analysis module 28D generates a performance improvement list (444). For example, performance analysis module 28D may determine various performance metrics for a plurality of entities based on historical repair data 234, such as performance metrics for each worker within one or more repair facilities, performance metrics for individual repair facilities, and/or performance metrics for a group of associated repair facilities (e.g., repair facilities owned by the same company). In one example, performance analysis module 28D determines performance metrics for different repairs and/or different types of vehicles. In some examples, performance analysis module 28D determines an aggregate performance metric for a plurality of entities.

In some instances, performance analysis module 28D compares the performance metrics across entities. For instance, performance analysis module 28D may compare one entity to the performance metrics of another entity or a set of entities. In one instance, performance analysis module 28D may identify entities that take longer than a threshold amount of time, use too little or too much material, use the wrong materials, etc. In other examples, the performance improvement list may indicate entities that perform one or more types of repairs with relatively low performance. Performance analysis module 28D may identify entities with relatively low performance based on the performance metrics and generate the performance improvement list that includes data indicating the entities with relatively low performance and the associated performance metrics for that entity.

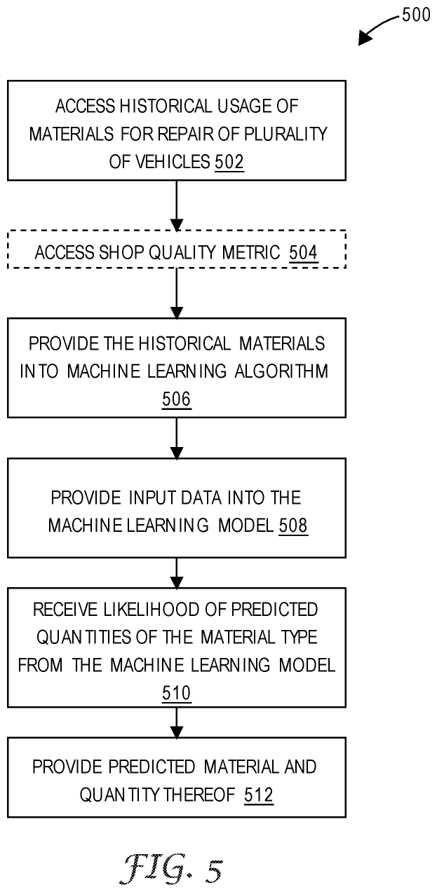

FIG. 5 illustrates a method 500 performed by the VRMS of predicting materials to be used during the vehicle repair and also the predicting of the quantities thereof. The method 500 can be a subprocess of block 306 in FIG. 3. In block 306, the VRMS can predict the materials to be used in the vehicle repair process.

In at least one embodiment, the use of machine learning models can drastically improve the prediction of the underlying data. Because the machine learning model is trained on data within the datastores prior to being used by the VRMS, the VRMS is able to reduce network bandwidth by not performing regression analysis for every material prediction from the repair and vehicle class. Instead, the VRMS can use the weights within the machine learning model to arrive at a similar prediction without having to access the underlying data in real-time.

In block 502, the VRMS can be configured to access the historical use of materials and quantities thereof and/or the existing repair specifications for a plurality of vehicles (which may further specify the materials and quantities thereof. The vehicles can be different vehicle classes or the same class type. For example, each vehicle class can have repair specifications that call for the amount of adhesive used depending on the repair. The historical use of materials of discrete consumables can be determined per vehicle or per each vehicle class. For example, the total abrasive discs per vehicle can be divided by a total amount over a time period divided by the number of vehicles (or the number of vehicles in a specific class) serviced in the time period.

Thus, given historical measurements of material usage for a defined repair specification across a series of different shop locations, the VRMS can generate a model for both the material to employ in the repair as well as the likely quantity (or range of quantity) needed to satisfy the repair.

In block 504, the VRMS can optionally access the quality metrics for the entity performing the vehicle repair. The quality metrics can be stored on a separate datastore from the historical usage of materials. For example, the quality metrics can be reviews of the entity performing the vehicle repair such as OEM feedback for certified repairs or can be consumer feedback and reviews of the entity. In at least one embodiment, the quality metric can also be based on the conformance to specific training and technical competence as indicated by, for example but not limited to, iCAR certification, inclusion in OEM preferred shop network, and insurance-preferred shops listings. These repair facilities may be more prepared to complete the repairs on those specific vehicles, and have equipment to appropriately do so, have technicians who have been trained on specific techniques, and have the actual manufacturer-recommended material and procedures to complete those repairs. In at least one embodiment, a weighted metric can be used to determine the amount of the continuous materials based on consideration of these new “quality” metrics.

In block 506, the data from block 502 and optionally block 504 can be provided into a machine learning algorithm in the VRMS. Examples of machine learning algorithms can include regression learning algorithms such as linear regression, lasso linear regression, ridge regression, elastic net regression, Gaussian process regression, and classification and regression trees. The regression learning algorithms can be used to train on continuous data such as the quantity of predicted material. Similarly, the machine learning algorithm can include classification algorithms to train on discrete data such as the predicted material. The classification algorithms can include k-nearest neighbors, Naive Bayes classifier, decision trees, random forest algorithms.

In at least one embodiment, the machine learning algorithm can be trained based on repair performance metrics and quality metrics.

Different confidence levels can be associated with the repairs done at the different entity locations (could be a single score for the shop across time or record level scores based on a snapshot of that shops performance at the time specified by the repair), and the machine learning algorithm could then be trained using the relative weights of the different repair records to more accurately predict the quantity needed under the predicted repair scenario. In at least one embodiment, the machine learning algorithm can perform classification on the quality metric to try to classify the material usage as high quality. Once a machine learning model is generated, then the machine learning model can weight the higher quality metric entities as more predicative of the material usage for a repair.

The machine learning model could be built on either the full corpus of data or on a slice for which the historical data is most similar to the current repair (specifications/characteristics of the repair directly match, or how fuzzy is the matching between records, same make/model/year, similar make/model, etc.).

In at least one embodiment, instead of being input into a machine learning model in block 506, the data from block 502 can be output to a repair order and/or to the records associated with a repair order for the purposes of completing a “Certified Repair” and/or to form the basis for communication to the insurance company to have an invoice adjustment (to bill for more than what was in the estimate).

Once the machine learning model is built/trained, in block 508, the VRMS can provide data into the machine learning model. The input data can be related to the material type, vehicle classes, (current or historical) repair data, or combinations thereof. In one example, the vehicle class and the current repair data can be input into the machine learning model.

In block 510, the VRMS can receive a likelihood of the predicted materials being present in the repair and any quantities thereof across a plurality of vehicles. For example, the machine learning model can generate a quantity value directly or generate a confidence interval to identify the potential range of material needed to satisfy the current repair for planning purposes. From this likelihood in block 510, the VRMS can determine the predicted material and the predicted quantity thereof in block 512.

Although the methods and systems of the present disclosure have been described with reference to specific exemplary embodiments, those of ordinary skill in the art will readily appreciate that changes and modifications may be made thereto without departing from the spirit and scope of the present disclosure.

In this disclosure, reference is made to the accompanying drawings, which illustrate specific embodiments in which the invention may be practiced. The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

The term “material”, as used herein, refers to items used in the repair of a vehicle and includes, without limitation, adhesives, sealers, abrasives, tapes, paints, coatings and tools.

The term “vehicle”, as used herein, refers to a machine for transporting goods and/or people and includes, without limitation, automobiles, motorcycles, trucks, recreational vehicles (RV's), and boats.

“Continuous data” refers to data that can be multiple values within a range. For example, quantities of a tube of adhesive can be any value up to 1 such as half a tube, or a third of a tube.

“Datastore” refers to a repository for persistently storing and managing collections of data which can include databases or even simple file types.

“Discrete data” refers to data that can take only certain values.

“Entity performing the vehicle repair” refers to an entity or organization that repairs vehicles. The entity can be an organization such as a multishop organization or can be a single shop. Generally, the entity can be defined by the data collection and sharing. For example, separate entities can exist if the entities operate on independent networks or file systems.

“Machine learning algorithm” refers to a procedure that is run on data. Machine learning algorithms can be for classification, regression, or clustering.

“Machine learning model” refers to the output of a machine learning algorithm specifically trained on training data. The machine learning model can make predictions based off of the learning.

“Non-discrete” refers to not divided into discrete parts.

“Predicted material repair plan” refers to a set of instructions that inform the material type and the quantity of each material type that the vehicle is predicted to use. The predicted material repair plan may differ from the actual material used.

“Vehicle class” refers to a class of vehicles that can be classified based on having certain properties. The vehicle class can include any of a category (car, boat, heavy truck) make, model, year, or combinations thereof.

What is claimed is:

1. A computing system comprising:
a datastore comprising current repair data and at least one of historical data or an existing repair specification;
at least one processor configured to:
determine, based on current repair data and at least one of historical data or an existing repair specification in the datastore, a predicted material to be used during a vehicle repair, the vehicle repair including replacing or repairing a part of a vehicle;
determine a predicted quantity of the predicted material to be used during the vehicle repair based on the current repair data and at least one of the historical data or the existing repair specification, wherein the predicted quantity is continuous data;
determine a predicted material repair (PMR) plan that includes the predicted material and predicted quantity of the predicted material for the vehicle; and
perform at least one action in response to determining the PMR plan.

2. The computing system of claim 1, wherein the at least one processor is configured to determine the predicted quantity of the predicted material by:
providing the current repair data and a vehicle class into a machine learning model, and
receiving a likelihood of the predicted quantity of the predicted material from the machine learning model;
providing to the at least one processor the predicted quantity of the predicted material based on the likelihood.

3. The computing system of claim 2, further comprising: training a machine learning algorithm on the historical data, actual material used, or the existing repair specifications for a plurality of vehicles to form the machine learning model.

4. The computing system of claim 3, wherein training the machine learning algorithm comprises training the machine learning algorithm on an entity performing the vehicle repair, and the quality metrics for the entity.

5. The computing system of claim 1, wherein the at least one processor is configured to determine the predicted quantity of the predicted material based on historical repair data associated with an entity performing the vehicle repair, and wherein the at least one processor is further configured to:
determine, based on historical repair data associated with a plurality of entities, an average quantity of material used by the plurality of entities during vehicle repairs of a same type as a type of the vehicle repair; and
output data indicating the predicted quantity of the predicted material to be used by the entity and the average quantity of the material used by the plurality of entities.

6. The computing system of claim 1, wherein to perform at least one action the at least one processor is configured to communicate the PMR plan to a user.

7. The computing system of claim 1, wherein to perform at least one action the at least one processor is further configured to:
receive data indicating an actual material used during the vehicle repair;
determine whether the predicted material includes the actual material; and
output data indicating whether the vehicle repair was performed according to the PMR plan to a machine learning algorithm.

8. The computing system of claim 7, wherein the at least one processor is further configured to:
determine whether the actual quantity of the actual material is within a threshold of the predicted quantity of the PMR plan.

9. The computing system of claim 1, wherein the predicted material includes at least one of an adhesive, an abrasive, a sealer, a tape, a paint, a coating, or combinations thereof.

10. The computing system of claim 1, wherein to perform at least one action the at least one processor is further configured to:
determine a manufacturer specified material to be used during the vehicle repair;
determine whether the predicted material to be used includes the manufacturer specified material; and
output data indicating whether the predicted material to be used includes the manufacturer specified material, wherein the outputted data is provided to a third-party provider.

11. The computing system of claim 1, wherein the current repair data includes data indicating a mileage of the vehicle or a location of the vehicle.

12. The computing system of claim 1, wherein a model year of the vehicle is a new model year, wherein the historical repair data includes vehicle repair data for vehicle repairs of previous model years of a same type as a type of the vehicle and does not include vehicle repair data for vehicle repairs of the new model year of the type of the vehicle.

13. The computing system of claim 1, wherein to perform at least one action the at least one processor is further configured to: generate an order for additional materials based at least in part on the predicted material to be used during the vehicle repair.

14. The computing system of claim 1, wherein the at least one processor is further configured to determine the predicted quantity of the predicted material to be used during the vehicle repair further based on at least one of:
the type of the vehicle repair,
the trim level of the vehicle,
the vehicle identification number of the vehicle,
the mileage of the vehicle,
the location of the vehicle, or
a physical measurement of the part to be repaired or replaced.

15. A method comprising:
determining, using a computing system, based on current repair data and at least one of historical data or an existing repair specification from a datastore, a predicted material to be used during a vehicle repair, the vehicle repair including replacing or repairing a part of a vehicle, wherein the predicted material is continuous data and non-discrete;
determining a predicted quantity of the predicted material to be used during the vehicle repair based on the current repair data and at least one of the historical data or the existing repair specification;
determining a predicted material repair plan that includes the predicted material and predicted quantity of the predicted material for the vehicle; and
performing at least one action in response to determining the PMR plan.

16. The method of claim 15, further comprising:
receiving data indicating an actual material used during the vehicle repair;
determining whether the actual material includes the predicted material; and
output data indicating whether the vehicle repair was performed according to the PMR plan.

17. The method of claim 16, further comprising:
determining whether the actual quantity of the actual material is within a threshold of a quantity defined by the PMR plan.

18. The method of claim 15, further comprising:
determining a manufacturer specified material to be used during the vehicle repair;
determining whether the predicted material to be used includes the manufacturer specified material; and
outputting data indicating whether the predicted material to be used includes the manufacturer specified material.

19. The method of claim 15, wherein the current repair data includes data indicating at least one of a type of the vehicle repair, a trim level of the vehicle, a vehicle identification number of the vehicle, a mileage of the vehicle, and a location of the vehicle.

20. A non-transitory computer-readable storage medium including instructions that, when processed by a computer, configure the computer to perform the method of claim 15.
